(19) United States
(12) Patent Application Publication
(10) Pub. No.: US 2019/0332109 A1
(43) Pub. Date: Oct. 31, 2019

(54) SYSTEMS AND METHODS FOR AUTONOMOUS DRIVING USING NEURAL NETWORK-BASED DRIVER LEARNING ON TOKENIZED SENSOR INPUTS

(71) Applicant: GM GLOBAL TECHNOLOGY OPERATIONS LLC, Detroit, MI (US)

(72) Inventors: Soheil Kolouri, Calabasas, CA (US); Cedrick G. Ngalande, Sunnyvale, CA (US); Kyungnam Kim, Oak Park, CA (US); Michael J. Daily, Thousand Oaks, CA (US)

(73) Assignee: GM GLOBAL TECHNOLOGY OPERATIONS LLC, Detroit, MI (US)

(21) Appl. No.: 15/964,401

(22) Filed: Apr. 27, 2018

(51) Int. Cl. G05D 1/00; G05D 1/02; G06N 3/04; G06N 3/08; G06K 9/00; B60W 10/20

(52) U.S. Cl. CPC G05D 1/0088; G05D 1/0221; G06N 3/0454; G05D 2201/0213; G06K 9/00805; B60W 10/20; G06N 3/08

(57) ABSTRACT

In various embodiments, methods, systems, and autonomous vehicles are provided. In one exemplary embodiment, a method is provided that includes obtaining first sensor inputs pertaining to one or more actors in proximity to an autonomous vehicle; obtaining second sensor inputs pertaining to operation of the autonomous vehicle; obtaining, via a processor, first neural network outputs via a first neural network, using the first sensor inputs; and obtaining, via the processor, second neural network outputs via a second neural network, using the first network outputs and the second sensor inputs, the second neural network outputs providing one or more recommended actions for controlling the autonomous vehicle.

### TECHNICAL FIELD

The present disclosure generally relates to vehicles, and more particularly relates to systems and methods for controlling autonomous vehicles via neural network-based driver learning.

An autonomous vehicle is a vehicle that is capable of sensing its environment and navigating with little or no user input. It does so by using sensing devices such as radar, lidar, image sensors, and the like. Autonomous vehicles further use information from global positioning systems (GPS) technology, navigation systems, vehicle-to-vehicle communication, vehicle-to-infrastructure technology, and/or drive-by-wire systems to navigate the vehicle.

While autonomous vehicles offer many potential advantages over traditional vehicles, in certain circumstances it may be desirable for improved control of movement of autonomous vehicles, for example in controlling autonomous vehicles based on learning of driver behavior (hereinafter referred to as driver learning).

Accordingly, it is desirable to provide systems and methods for controlling autonomous vehicles based on driver learning. Furthermore, other desirable features and characteristics of the present disclosure will become apparent from the subsequent detailed description and the appended claims, taken in conjunction with the accompanying drawings and the foregoing technical field and background.

### SUMMARY

In one exemplary embodiment, a method includes obtaining first sensor inputs pertaining to one or more actors in proximity to an autonomous vehicle; obtaining second sensor inputs pertaining to operation of the autonomous vehicle; obtaining, via a processor, first neural network outputs via a first neural network, using the first sensor inputs; and obtaining, via the processor, second neural network outputs via a second neural network, using the first network outputs and the second sensor inputs, the second neural network outputs providing one or more recommended actions for controlling the autonomous vehicle.

Also in one embodiment, the first neural network includes a recurrent neural network.

Also in one embodiment, the first neural network includes a deep recurrent neural network; and the second neural network includes a deep neural network.

Also in one embodiment, the step of obtaining the first sensor inputs includes obtaining first operational parameters for one or more other vehicles in proximity to the autonomous vehicle; and the step of obtaining the first neural network outputs includes obtaining the first neural network outputs, via the first neural network, using the first operational parameters for the one or more other vehicles in proximity to the autonomous vehicle.

Also in one embodiment, the method further includes providing one or more vehicle actions for controlling acceleration, deceleration, or steering of the autonomous vehicle, when the autonomous vehicle is in an operational mode.

Also in one embodiment, the method further includes, when the autonomous vehicle is in a training mode: obtaining observational data pertaining to a human's operation of the autonomous vehicle; comparing the human's operation of the autonomous vehicle from the observational data with the recommended actions of the second neural network outputs; and updating the first neural network and the second neural network based on the comparing of the human's operation of the autonomous vehicle from the observational data with the recommended actions of the second neural network outputs.

Also in one embodiment, the step of obtaining the first sensor inputs includes obtaining tokenized sensor inputs pertaining to one or more actors in proximity to an autonomous vehicle; and the step of obtaining the first neural network outputs includes obtaining the first neural network outputs via the first neural network, using the tokenized sensor inputs pertaining to one or more actors in proximity to an autonomous vehicle.

In another exemplary embodiment, a system includes a sensing module and a processing module. The sensing module is for an autonomous vehicle, and is configured to at least facilitate: obtaining first sensor inputs pertaining to one or more actors in proximity to an autonomous vehicle; and obtaining second sensor inputs pertaining to operation of the autonomous vehicle. The processing module has a processor, is coupled to the sensing module, and is configured to at least facilitate: obtaining first neural network outputs via a first neural network, using the first sensor inputs; and obtaining second neural network outputs via a second neural network, using the first neural network outputs and the second sensor inputs, the second neural network outputs providing one or more recommended actions for controlling the autonomous vehicle.

Also in one embodiment, the first neural network includes a recurrent neural network.

Also in one embodiment, the first neural network includes a deep recurrent neural network; and the second neural network includes a deep neural network.

Also in one embodiment, wherein the sensing module is configured to at least facilitate obtaining first operational parameters for one or more other vehicles in proximity to the autonomous vehicle; and the processing module is configured to at least facilitate obtaining the first neural network outputs, via the first neural network, using the first operational parameters for the one or more other vehicles in proximity to the autonomous vehicle.

Also in one embodiment, the processing module is configured to at least facilitate providing one or more vehicle actions for controlling acceleration, deceleration, or steering of the autonomous vehicle, when the autonomous vehicle is in an operational mode.

Also in one embodiment, the processing module is configured to at least facilitate, when the autonomous vehicle is in a training mode: obtaining observational data pertaining to a human's operation of the autonomous vehicle; comparing the human's operation of the autonomous vehicle from the observational data with the recommended actions of the second neural network outputs; and updating the first neural network and the second neural network based on the comparing of the human's operation of the autonomous vehicle from the observational data with the recommended actions of the second neural network outputs.

Also in one embodiment, the sensing module is configured to at least facilitate obtaining tokenized sensor inputs pertaining to one or more actors in proximity to an autonomous vehicle; and the processing module is configured to at least facilitate obtaining the first neural network outputs via the first neural network, using the tokenized sensor inputs pertaining to one or more actors in proximity to an autonomous vehicle.

In another exemplary embodiment, an autonomous vehicle includes a body, a propulsion system, and one or more sensors. The propulsion system is configured to move the body. The one or more sensors are disposed within the body, and are configured to at least facilitate: obtaining first sensor inputs pertaining to one or more actors in proximity to an autonomous vehicle; and obtaining second sensor inputs pertaining to operation of the autonomous vehicle. The one or more processors are disposed within the body, and are configured to at least facilitate: obtaining first neural network outputs via a first neural network, using the first sensor inputs; and obtaining second neural network outputs via a second neural network, using the first neural network outputs and the second sensor inputs, the second neural network outputs providing one or more recommended actions for controlling the autonomous vehicle.

Also in one embodiment, the first neural network includes a deep recurrent neural network; and the second neural network includes a deep neural network.

Also in one embodiment, the one or more sensors are configured to at least facilitate obtaining first operational parameters for one or more other vehicles in proximity to the autonomous vehicle; and the one or more processors are configured to at least facilitate obtaining the first neural network outputs, via the first neural network, using the first operational parameters for the one or more other vehicles in proximity to the autonomous vehicle.

Also in one embodiment, the one or more processors are configured to at least facilitate: when the autonomous vehicle is in an operational mode, providing one or more vehicle actions for controlling acceleration, deceleration, or steering of the autonomous vehicle; and when the autonomous vehicle is in a training mode: obtaining observational data pertaining to a human's operation of the autonomous vehicle; comparing the human's operation of the autonomous vehicle from the observational data with the recommended actions of the second neural network outputs; and updating the first neural network and the second neural network based on the comparing of the human's operation of the autonomous vehicle from the observational data with the recommended actions of the second neural network outputs.

Also in one embodiment, the one or more sensors are configured to at least facilitate obtaining tokenized sensor inputs pertaining to one or more actors in proximity to an autonomous vehicle; and the one or more processors are configured to at least facilitate obtaining the first neural network outputs via the first neural network, using the tokenized sensor inputs pertaining to one or more actors in proximity to an autonomous vehicle.

Also in one embodiment, the autonomous vehicle further includes a memory disposed within the body and configured to store the first neural network and the second neural network.

### DESCRIPTION OF THE DRAWINGS

The exemplary embodiments will hereinafter be described in conjunction with the following drawing figures, wherein like numerals denote like elements, and wherein:

FIG. 1 is a functional block diagram illustrating an autonomous vehicle having a control system that controls vehicle actions based on driver learning using neural networks, in accordance with exemplary embodiments;

FIG. 2 is a functional block diagram illustrating a transportation system having one or more vehicles as shown in FIG. 1, in accordance with various embodiments;

FIG. 3 is functional block diagram illustrating an autonomous driving system (ADS) having a control system associated with the vehicle of FIG. 1, in accordance with various embodiments;

FIG. 4 is a functional block diagram illustrating the control system, in accordance with various embodiments;

FIG. 5 is a flowchart for a control process for controlling vehicle actions based on driver learning using neural networks, and that can be implemented in connection with the vehicle and control systems of FIGS. 1-4, in accordance with various embodiments; and

FIG. 6 is a functional block diagram of an architecture for implementing the control system of FIGS. 1-4 and the process of FIG. 5, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary, or the following detailed description. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, machine learning, image analysis, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

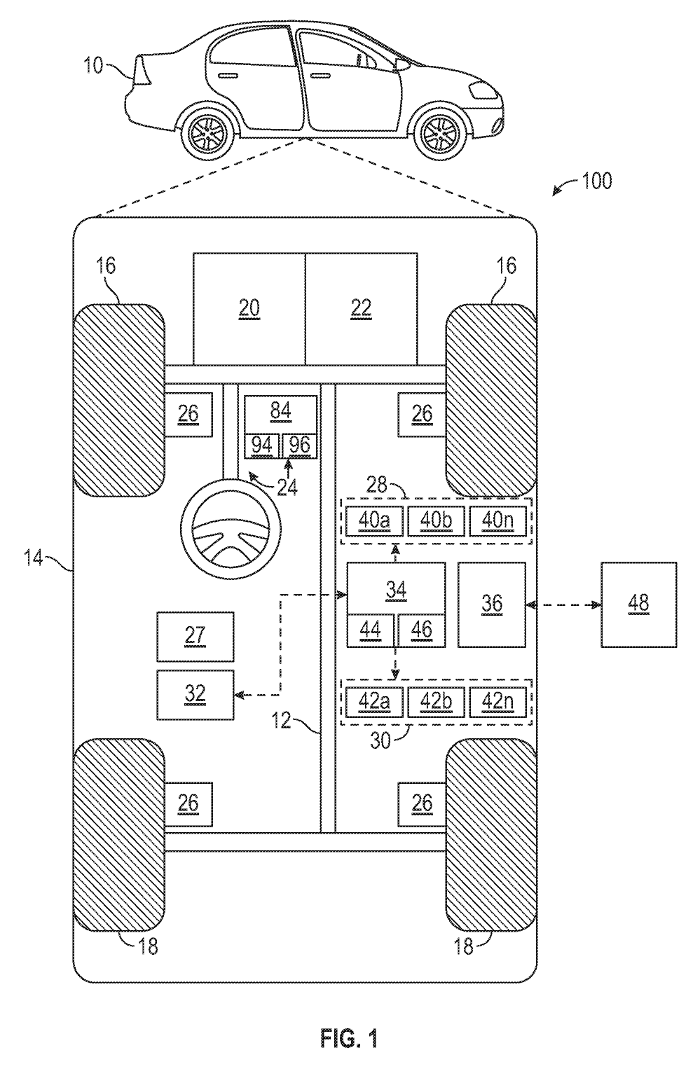

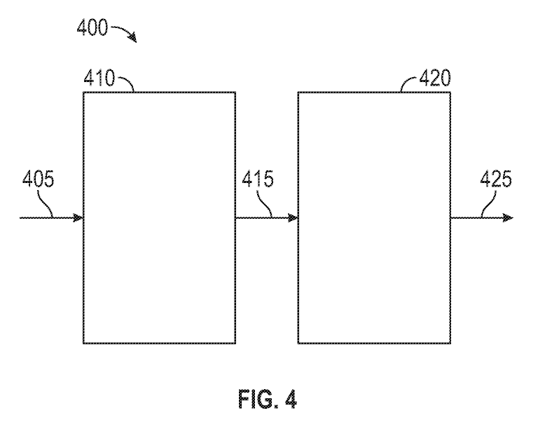

With reference to FIG. 1, a control system 100 is associated with a vehicle 10 (also referred to herein as a “host vehicle”) in accordance with various embodiments. In general, the control system (or simply “system”) 100 provides for control of various actions of the vehicle 10 (e.g., steering, acceleration, deceleration, braking, and so on) based on neural network-based learning of driver behavior using tokenized sensor inputs, for example as described in greater detail further below in connection with FIGS. 4-6.

As depicted in FIG. 1, the vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14. In various embodiments, the wheels 16, 18 comprise a wheel assembly that also includes respective associated tires.

In various embodiments, the vehicle 10 is an autonomous vehicle, and the control system 100, and/or components thereof, are incorporated into the vehicle 10. The vehicle 10 is, for example, a vehicle that is automatically controlled to carry passengers from one location to another. The vehicle 10 is depicted in the illustrated embodiment as a passenger car, but it should be appreciated that any other vehicle, including motorcycles, trucks, sport utility vehicles (SUVs), recreational vehicles (RVs), marine vessels, aircraft, and the like, can also be used.

In an exemplary embodiment, the vehicle 10 corresponds to a level four or level five automation system under the Society of Automotive Engineers (SAE) “J3016” standard taxonomy of automated driving levels. Using this terminology, a level four system indicates “high automation,” referring to a driving mode in which the automated driving system performs all aspects of the dynamic driving task, even if a human driver does not respond appropriately to a request to intervene. A level five system, on the other hand, indicates “full automation,” referring to a driving mode in which the automated driving system performs all aspects of the dynamic driving task under all roadway and environmental conditions that can be managed by a human driver. It will be appreciated, however, the embodiments in accordance with the present subject matter are not limited to any particular taxonomy or rubric of automation categories.

As shown, the vehicle 10 generally includes a propulsion system 20, a transmission system 22, a steering system 24, a brake system 26, one or more user input devices 27, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16 and 18 according to selectable speed ratios. According to various embodiments, the transmission system 22 may include a step-ratio automatic transmission, a continuously-variable transmission, or other appropriate transmission.

The brake system 26 is configured to provide braking torque to the vehicle wheels 16 and 18. Brake system 26 may, in various embodiments, include friction brakes, brake by wire, a regenerative braking system such as an electric machine, and/or other appropriate braking systems.

The steering system 24 influences a position of the vehicle wheels 16 and/or 18. While depicted as including a steering wheel for illustrative purposes, in some embodiments contemplated within the scope of the present disclosure, the steering system 24 may not include a steering wheel.

The controller 34 includes at least one processor 44 and a computer-readable storage device or media 46. As noted above, in various embodiments, the controller 34 (e.g., the processor 44 thereof) provides data pertaining to a projected future path of the vehicle 10, including projected future steering instructions, to the steering control system 84 in advance, for use in controlling steering for a limited period of time in the event that communications with the steering control system 84 become unavailable. Also in various embodiments, the controller 34 provides communications to the steering control system 84 34 via the communication system 36 described further below, for example via a communication bus and/or transmitter (not depicted in FIG. 1).

In various embodiments, the controller 34 includes at least one processor 44 and a computer-readable storage device or media 46. The processor 44 may be any custom-made or commercially available processor, a central processing unit (CPU), a graphics processing unit (GPU), an auxiliary processor among several processors associated with the controller 34, a semiconductor-based microprocessor (in the form of a microchip or chip set), any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store multiple neural networks, along with various operating variables, while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the vehicle 10, and generate control signals that are transmitted to the actuator system 30 to automatically control the components of the vehicle 10 based on the logic, calculations, methods, and/or algorithms. Although only one controller 34 is shown in FIG. 1, embodiments of the vehicle 10 may include any number of controllers 34 that communicate over any suitable communication medium or a combination of communication mediums and that cooperate to process the sensor signals, perform logic, calculations, methods, and/or algorithms, and generate control signals to automatically control features of the vehicle 10.

As depicted in FIG. 1, the vehicle 10 generally includes, in addition to the above-referenced steering system 24 and controller 34, a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14. In various embodiments, the wheels 16, 18 comprise a wheel assembly that also includes respective associated tires.

In various embodiments, the vehicle 10 is an autonomous vehicle, and the control system 100, and/or components thereof, are incorporated into the vehicle 10. The vehicle 10 is, for example, a vehicle that is automatically controlled to carry passengers from one location to another. The vehicle 10 is depicted in the illustrated embodiment as a passenger car, but it should be appreciated that any other vehicle, including motorcycles, trucks, sport utility vehicles (SUVs), recreational vehicles (RVs), marine vessels, aircraft, and the like, can also be used.

In an exemplary embodiment, the vehicle 10 corresponds to a level four or level five automation system under the Society of Automotive Engineers (SAE) “J3016” standard taxonomy of automated driving levels. Using this terminology, a level four system indicates “high automation,” referring to a driving mode in which the automated driving system performs all aspects of the dynamic driving task, even if a human driver does not respond appropriately to a request to intervene. A level five system, on the other hand, indicates “full automation,” referring to a driving mode in which the automated driving system performs all aspects of the dynamic driving task under all roadway and environmental conditions that can be managed by a human driver. It will be appreciated, however, the embodiments in accordance with the present subject matter are not limited to any particular taxonomy or rubric of automation categories. Furthermore, systems in accordance with the present embodiment may be used in conjunction with any autonomous, non-autonomous, or other vehicle that includes sensors and a suspension system.

As shown, the vehicle 10 generally also includes a propulsion system 20, a transmission system 22, a brake system 26, one or more user input devices 27, a sensor system 28, an actuator system 30, at least one data storage device 32, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16 and 18 according to selectable speed ratios. According to various embodiments, the transmission system 22 may include a step-ratio automatic transmission, a continuously-variable transmission, or other appropriate transmission.

The brake system 26 is configured to provide braking torque to the vehicle wheels 16 and 18. Brake system 26 may, in various embodiments, include friction brakes, brake by wire, a regenerative braking system such as an electric machine, and/or other appropriate braking systems.

The steering system 24 influences a position of the vehicle wheels 16 and/or 18. While depicted as including a steering wheel for illustrative purposes, in some embodiments contemplated within the scope of the present disclosure, the steering system 24 may not include a steering wheel.

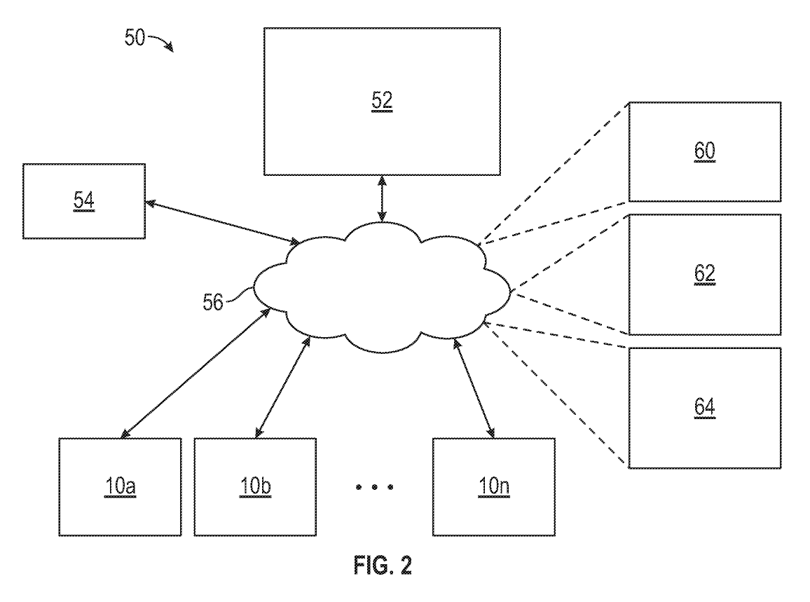

In various embodiments, one or more user input devices 27 receive inputs from one or more passengers of the vehicle 10. In various embodiments, the inputs include a desired destination of travel for the vehicle 10. In certain embodiments, one or more input devices 27 comprise an interactive touch-screen in the vehicle 10. In certain embodiments, one or more inputs devices 27 comprise a speaker for receiving audio information from the passengers. In certain other embodiments, one or more input devices 27 may comprise one or more other types of devices and/or may be coupled to a user device (e.g., smart phone and/or other electronic device) of the passengers, such as the user device 54 depicted in FIG. 2 and described further below in connection therewith).

The sensor system 28 includes one or more sensors 40a-40n that sense observable conditions of the exterior environment and/or the interior environment of the vehicle 10. The sensors 40a-40n include, but are not limited to, radars, lidars, global positioning systems, optical cameras, thermal cameras, ultrasonic sensors, inertial measurement units, and/or other sensors.

The actuator system 30 includes one or more actuators 42a-42n that control one or more vehicle features such as, but not limited to, the propulsion system 20, the transmission system 22, the steering system 24, and the brake system 26. In various embodiments, vehicle 10 may also include interior and/or exterior vehicle features not illustrated in FIG. 1, such as various doors, a trunk, and cabin features such as air, music, lighting, touch-screen display components (such as those used in connection with navigation systems), and the like.

The data storage device 32 stores data for use in automatically controlling the vehicle 10. In various embodiments, the data storage device 32 stores defined maps of the navigable environment. In various embodiments, the defined maps may be predefined by and obtained from a remote system (described in further detail with regard to FIG. 2). For example, the defined maps may be assembled by the remote system and communicated to the vehicle 10 (wirelessly and/or in a wired manner) and stored in the data storage device 32. Route information may also be stored within data storage device 32—i.e., a set of road segments (associated geographically with one or more of the defined maps) that together define a route that the user may take to travel from a start location (e.g., the user's current location) to a target location. As will be appreciated, the data storage device 32 may be part of the controller 34, separate from the controller 34, or part of the controller 34 and part of a separate system.

The controller 34 includes at least one processor 44 and a computer-readable storage device or media 46. The processor 44 may be any custom-made or commercially available processor, a central processing unit (CPU), a graphics processing unit (GPU), an auxiliary processor among several processors associated with the controller 34, a semiconductor-based microprocessor (in the form of a microchip or chip set), any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the vehicle 10, and generate control signals that are transmitted to the actuator system 30 to automatically control the components of the vehicle 10 based on the logic, calculations, methods, and/or algorithms. Although only one controller 34 is shown in FIG. 1, embodiments of the vehicle 10 may include any number of controllers 34 that communicate over any suitable communication medium or a combination of communication mediums and that cooperate to process the sensor signals, perform logic, calculations, methods, and/or algorithms, and generate control signals to automatically control features of the vehicle 10.

The communication system 36 is configured to wirelessly communicate information to and from other entities 48, such as but not limited to, other vehicles (“V2V” communication), infrastructure (“V2I” communication), remote transportation systems, and/or user devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

In various embodiments, the communication system 36 is used for communications between the controller 34, including data pertaining to a projected future path of the vehicle 10, including projected future steering instructions. Also in various embodiments, the communication system 36 may also facilitate communications between the steering control system 84 and/or or more other systems and/or devices.

In certain embodiments, the communication system 36 is further configured for communication between the sensor system 28, the input device 27, the actuator system 30, one or more controllers (e.g., the controller 34), and/or more other systems and/or devices (such as, by way of example, the user device 54 depicted in FIG. 2 and described further below in connection therewith). For example, the communication system 36 may include any combination of a controller area network (CAN) bus and/or direct wiring between the sensor system 28, the actuator system 30, one or more controllers 34, and/or one or more other systems and/or devices. In various embodiments, the communication system 36 may include one or more transceivers for communicating with one or more devices and/or systems of the vehicle 10, devices of the passengers (e.g., the user device 54 of FIG. 2), and/or one or more sources of remote information (e.g., GPS data, traffic information, weather information, and so on).

With reference now to FIG. 2, in various embodiments, the vehicle 10 described with regard to FIG. 1 may be suitable for use in the context of a taxi or shuttle system in a certain geographical area (e.g., a city, a school or business campus, a shopping center, an amusement park, an event center, or the like) or may simply be managed by a remote system. For example, the vehicle 10 may be associated with an autonomous vehicle based remote transportation system. FIG. 2 illustrates an exemplary embodiment of an operating environment shown generally at 50 that includes an autonomous vehicle based remote transportation system (or simply “remote transportation system”) 52 that is associated with one or more vehicles 10a-10n as described with regard to FIG. 1. In various embodiments, the operating environment 50 (all or a part of which may correspond to entities 48 shown in FIG. 1) further includes one or more user devices 54 that communicate with the vehicle 10 and/or the remote transportation system 52 via a communication network 56.

The communication network 56 supports communication as needed between devices, systems, and components supported by the operating environment 50 (e.g., via tangible communication links and/or wireless communication links). For example, the communication network 56 may include a wireless carrier system 60 such as a cellular telephone system that includes a plurality of cell towers (not shown), one or more mobile switching centers (MSCs) (not shown), as well as any other networking components required to connect the wireless carrier system 60 with a land communications system. Each cell tower includes sending and receiving antennas and a base station, with the base stations from different cell towers being connected to the MSC either directly or via intermediary equipment such as a base station controller. The wireless carrier system 60 can implement any suitable communications technology, including for example, digital technologies such as CDMA (e.g., CDMA2000), LTE (e.g., 4G LTE or 5G LTE), GSM/GPRS, or other current or emerging wireless technologies. Other cell tower/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from including the wireless carrier system 60, a second wireless carrier system in the form of a satellite communication system 64 can be included to provide uni-directional or bi-directional communication with the vehicles 10a-10n. This can be done using one or more communication satellites (not shown) and an uplink transmitting station (not shown). Uni-directional communication can include, for example, satellite radio services, wherein programming content (news, music, and the like) is received by the transmitting station, packaged for upload, and then sent to the satellite, which broadcasts the programming to subscribers. Bi-directional communication can include, for example, satellite telephony services using the satellite to relay telephone communications between the vehicle 10 and the station. The satellite telephony can be utilized either in addition to or in lieu of the wireless carrier system 60.

A land communication system 62 may further be included that is a conventional land-based telecommunications network connected to one or more landline telephones and connects the wireless carrier system 60 to the remote transportation system 52. For example, the land communication system 62 may include a public switched telephone network (PSTN) such as that used to provide hardwired telephony, packet-switched data communications, and the Internet infrastructure. One or more segments of the land communication system 62 can be implemented through the use of a standard wired network, a fiber or other optical network, a cable network, power lines, other wireless networks such as wireless local area networks (WLANs), or networks providing broadband wireless access (BWA), or any combination thereof. Furthermore, the remote transportation system 52 need not be connected via the land communication system 62, but can include wireless telephony equipment so that it can communicate directly with a wireless network, such as the wireless carrier system 60.

Although only one user device 54 is shown in FIG. 2, embodiments of the operating environment 50 can support any number of user devices 54, including multiple user devices 54 owned, operated, or otherwise used by one person. Each user device 54 supported by the operating environment 50 may be implemented using any suitable hardware platform. In this regard, the user device 54 can be realized in any common form factor including, but not limited to: a desktop computer; a mobile computer (e.g., a tablet computer, a laptop computer, or a netbook computer); a smartphone; a video game device; a digital media player; a component of a home entertainment equipment; a digital camera or video camera; a wearable computing device (e.g., smart watch, smart glasses, smart clothing); or the like. Each user device 54 supported by the operating environment 50 is realized as a computer-implemented or computer-based device having the hardware, software, firmware, and/or processing logic needed to carry out the various techniques and methodologies described herein. For example, the user device 54 includes a microprocessor in the form of a programmable device that includes one or more instructions stored in an internal memory structure and applied to receive binary input to create binary output. In some embodiments, the user device 54 includes a GPS module capable of receiving GPS satellite signals and generating GPS coordinates based on those signals. In other embodiments, the user device 54 includes cellular communications functionality such that the device carries out voice and/or data communications over the communication network 56 using one or more cellular communications protocols, as are discussed herein. In various embodiments, the user device 54 includes a visual display, such as a touch-screen graphical display, or other display.

The remote transportation system 52 includes one or more backend server systems, not shown), which may be cloud-based, network-based, or resident at the particular campus or geographical location serviced by the remote transportation system 52. The remote transportation system 52 can be manned by a live advisor, an automated advisor, an artificial intelligence system, or a combination thereof. The remote transportation system 52 can communicate with the user devices 54 and the vehicles 10a-10n to schedule rides, dispatch vehicles 10a-10n, and the like. In various embodiments, the remote transportation system 52 stores store account information such as subscriber authentication information, vehicle identifiers, profile records, biometric data, behavioral patterns, and other pertinent sub scriber information.

In accordance with a typical use case workflow, a registered user of the remote transportation system 52 can create a ride request via the user device 54. The ride request will typically indicate the passenger's desired pickup location (or current GPS location), the desired destination location (which may identify a predefined vehicle stop and/or a user-specified passenger destination), and a pickup time. The remote transportation system 52 receives the ride request, processes the request, and dispatches a selected one of the vehicles 10a-10n (when and if one is available) to pick up the passenger at the designated pickup location and at the appropriate time. The transportation system 52 can also generate and send a suitably configured confirmation message or notification to the user device 54, to let the passenger know that a vehicle is on the way.

As can be appreciated, the subject matter disclosed herein provides certain enhanced features and functionality to what may be considered as a standard or baseline vehicle 10 and/or a vehicle based remote transportation system 52. To this end, a vehicle and vehicle based remote transportation system can be modified, enhanced, or otherwise supplemented to provide the additional features described in more detail below.

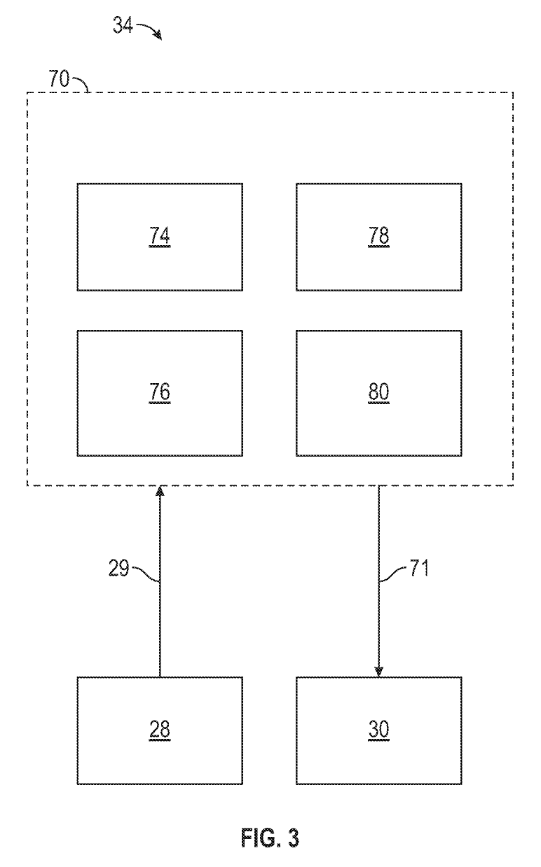

In accordance with various embodiments, the controller 34 implements an autonomous driving system (ADS) as shown in FIG. 3. That is, suitable software and/or hardware components of the controller 34 (e.g., processor 44 and computer-readable storage device 46) are utilized to provide an ADS that is used in conjunction with vehicle 10.

In various embodiments, the instructions of the autonomous driving system 70 may be organized by function or system. For example, as shown in FIG. 3, the autonomous driving system 70 can include a computer vision system 74, a positioning system 76, a guidance system 78, and a vehicle control system 80. As can be appreciated, in various embodiments, the instructions may be organized into any number of systems (e.g., combined, further partitioned, and the like) as the disclosure is not limited to the present examples.

In various embodiments, the computer vision system 74 synthesizes and processes sensor data and predicts the presence, location, classification, and/or path of objects and features of the environment of the vehicle 10. In various embodiments, the computer vision system 74 can incorporate information from multiple sensors, including but not limited to cameras, lidars, radars, and/or any number of other types of sensors.

The positioning system 76 processes sensor data along with other data to determine a position (e.g., a local position relative to a map, an exact position relative to lane of a road, vehicle heading, velocity, etc.) of the vehicle 10 relative to the environment. The guidance system 78 processes sensor data along with other data to determine a path for the vehicle 10 to follow. The vehicle control system 80 generates control signals for controlling the vehicle 10 according to the determined path.

In various embodiments, the controller 34 implements machine learning techniques to assist the functionality of the controller 34, such as feature detection/classification, obstruction mitigation, route traversal, mapping, sensor integration, ground-truth determination, and the like.

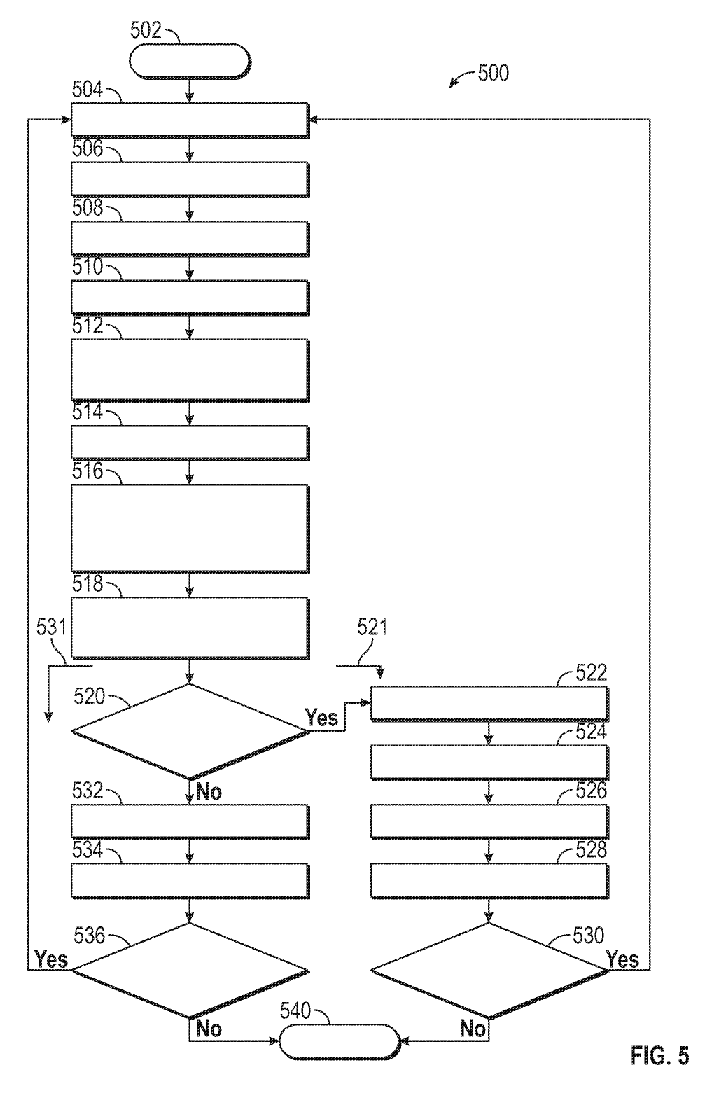

In various embodiments, as discussed above with regard to FIG. 1, one or more instructions of the controller 34 are embodied in the control system 100, for example for controlling various vehicle 10 actions (e.g., steering, accelerating, decelerating, braking, and so on) based on neural network-based driver learning for the control system 100 using tokenized sensor inputs. As used throughout this Application, in various embodiments, tokenized sensor inputs refer to mid-level information extracted from raw sensory inputs. In various embodiments, for an autonomous vehicle 10 with multi-sensory inputs, at a given time stamp, the tokenized sensor inputs identify the actors (e.g. cars, pedestrians, cyclists, and so on) and numerical descriptions for the actors including their coordinates with respect to the self (i.e. self driving vehicle 10), their speed, their acceleration, heading angle, for example as described in greater detail further below in connection with step 506 of the process 500 of FIG. 5.

Also in various embodiments, all or parts of the control system 100 may be embodied in the computer vision system 74, and/or the vehicle control system 80 or may be implemented as a separate system (referred to as a target assessment system 400), as shown.

Referring to FIG. 4 and with continued reference to FIG. 1, the control system 400 generally includes a sensing module 410 and a processing module 420. In various embodiments, both the sensing module 410 and the processing module 420 are disposed onboard the vehicle 10. In certain embodiments, one or both of the sensing module 410 and/or processing module 420, and/or components thereof, may be disposed remote from the vehicle 10 (e.g., on a remote server that communicates with the vehicle 10). As can be appreciated, in various embodiments, parts of the control system 400 may be disposed on a system remote from the vehicle 10 while other parts of the control system 400 may be disposed on the vehicle 10.

In various embodiments, the sensing module 410 obtains data from various sensors of the vehicle 10. For example, in certain embodiments, the sensing module 410 obtains sensor data from one or more sensors 40a-40n of FIG. 1 that sense observable conditions of the exterior environment and/or the interior environment of the vehicle 10 (e.g., from one or more radars, lidars, global positioning systems, optical cameras, thermal cameras, ultrasonic sensors, inertial measurement units, and/or other sensors of the vehicle 10).

In various embodiments, the sensing module 410 obtains sensor data pertaining to other vehicles, pedestrians, bicyclists, animals, and/or other objects that may be in proximity to the vehicle 10 and/or a path thereof, and parameters pertaining to such objects (e.g., object type, position, heading angle, distance from the host vehicle 10, velocity, acceleration, and so on). Also in certain embodiments, the sensing module 410 receives sensor data as inputs 405, and provides the sensor data as outputs 415 to the processing module 420 (e.g., via the communication system 36 of FIG. 1). In certain embodiments, the sensing module 410 provides pre-processed, tokenized sensor data pertaining to various “actors” (e.g., other vehicles, pedestrians, bicyclists, animals, and/or other objects) that may be in proximity to the vehicle 10 and/or a path thereof; as well as observational data pertaining to an operator of the vehicle 10 (e.g., as to steering, accelerating, decelerating, braking, and/or other actions for the vehicle 10 based on operator actions), and provides the tokenized sensor data and the operational observation data as outputs 415 to the processing module 420.

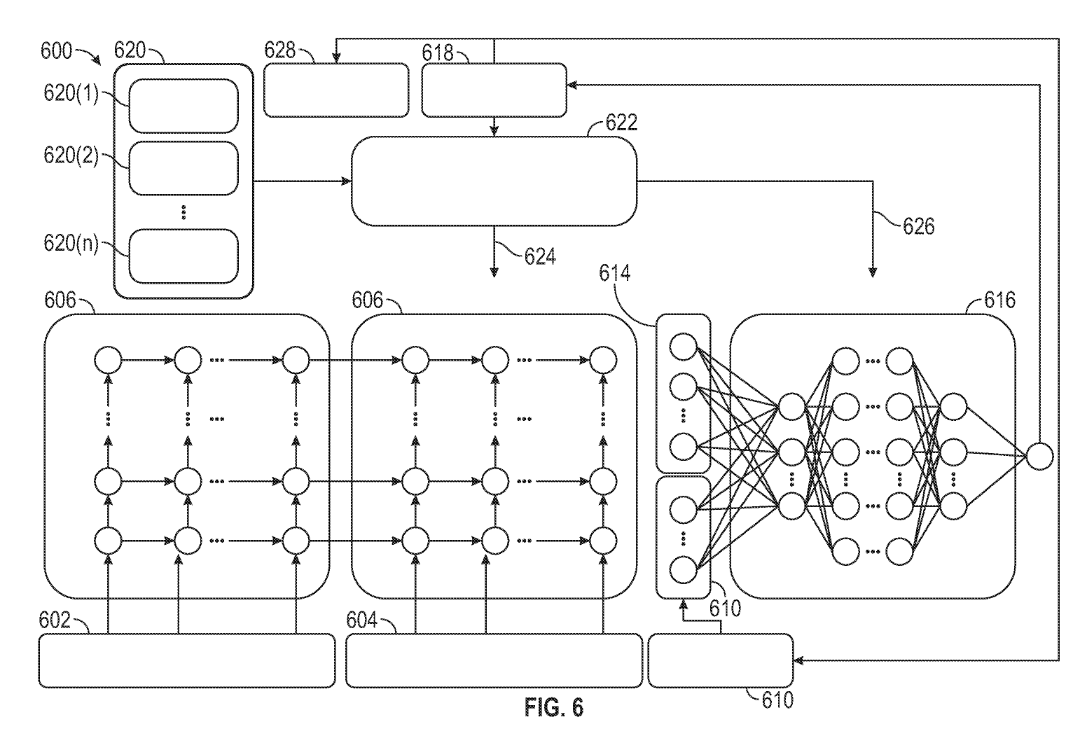

In various embodiments, the processing module 420 receives the sensor data as inputs 415, and processes the sensor data (among other types of data, in certain embodiments). In various embodiments, the processing module 420 processes the tokenized sensor data from the sensing module 410 using neural network models, and provides learning/training for neural network models of the vehicle 10 based on the processed tokenized sensor data and the operator observational data from the sensing module 410. In addition, in various embodiments, the processing module 420 provides instructions for the implementation of various vehicle control actions (e.g., steering, accelerating, decelerating, braking, and/or other actions for the vehicle 10) based on the trained neural network models. In various embodiments, the processing module 420 provides outputs 425 for the training of the neural network models and for the control of the vehicle 10 (e.g., for steering, accelerating, decelerating, braking, and/or other actions for the vehicle 10) using the neural network models, for example as described greater below in connection with the process 500 of FIG. 5 and the associated architecture thereof of FIG. 6.

Turning now to FIG. 5, a flowchart for a control process 500 is provided for controlling an autonomous vehicle based on neural network-based operator learning, in accordance with exemplary embodiments. In various embodiments, the control process can be implemented in connection with the vehicle 10, control system 100, propulsion system 20, steering system 24, brake system 26, controller 34, and control systems 100, 400 of FIGS. 1-4, in accordance with various embodiments. Also in various embodiments, the control process 500 is also described below in connection with FIG. 6, which provides an exemplary architecture 600 for implementing the control systems 100, 400 of FGIS. 1-4 and the control process 500 of FIG. 5.

As can be appreciated in light of the disclosure, the order of operation within the control process 500 is not limited to the sequential execution as illustrated in FIG. 5, but may be performed in one or more varying orders as applicable and in accordance with the present disclosure. In various embodiments, the control process 500 can be scheduled to run based on one or more predetermined events, and/or can run continuously during operation of the vehicle 10.

Also per the discussion below, in certain embodiments, the process 500 may include a training mode and an operational mode. For example, in various embodiments, multiple neural networks are trained during a training mode, in which the vehicle 10 (and/or similar and/or other vehicles) are operated using human drivers. Once the neural networks are trained, they may be implemented in an autonomous vehicle (e.g., the vehicle 10) in an operational mode, in which the vehicle 10 is operated in an autonomous manner (without human drivers). While the process 500 of FIG. 5 (and the corresponding architecture 600 of FIG. 6) are discussed below in connection with both the training mode and the operational mode, it will be appreciated that in various embodiments the training mode and the operational mode may be performed not only at different times but also in different vehicles, and for example a vehicle 10 in the marketplace may operate solely in the operating mode in certain embodiments (for example, with neural networks that have already been trained via a training mode of the same vehicle 10 and/or other vehicles in various embodiments), and so on.

In various embodiments, the control process 500 may begin at 502. In various embodiments, step 502 occurs when an occupant is within the vehicle 10 and the vehicle 10 begins operation in an automated manner. In various embodiments, the vehicle 10 is operated in an autonomous manner to a desired destination based on a user input as to the desired destination, for example as obtained via the input unit 27 of FIG. 1.

Sensor data is obtained at 504. In various embodiments, sensor data is obtained from the sensing module 410 of FIG. 4 (e.g., via the various sensors 40a . . . 40n of FIG. 1). For example, in various embodiments, sensor data is obtained from cameras and/or other visions systems, lidar sensors, radar sensors, and/or one or more other sensors. Also in various embodiments, the sensor data may pertain to data observations pertaining to the vehicle 10 as well as surroundings for the vehicle 10 as it travels along a roadway.

In various embodiments, actor information is obtained at 506. In certain embodiments, the actor information includes information an identification of one or more “actors” in proximity to the vehicle 10 (e.g., other vehicles, pedestrians, bicyclists, animals, and/or other objects that may be in proximity to the vehicle 10 and/or a path thereof), and parameters pertaining to such actors (e.g., actor type, position, heading angle, distance from the host vehicle 10, velocity, acceleration, and so on). In various embodiments, the actor information of 504 is provided from the sensing module 410 to the processing module 420 as pre-processed, tokenized sensor data pertaining to various actors from the sensor data of 502, for use in vehicle control.

With reference to the architecture 600 of FIG. 6, in various embodiments, the actor information is obtained at various points in time. For example, as depicted in FIG. 6, in various embodiments, the actor information of 506 is represented as first actor information 602 at a previous time (t−1), along with second actor information 604 at a current time (t).

Also in various embodiments, host vehicle information (also referred to herein as vehicle information) is obtained at 508. In certain embodiments, the host vehicle information includes observational data pertaining to an operator of the vehicle 10 (e.g., as to steering, accelerating, decelerating, braking, and/or other actions for the vehicle 10 based on operator actions). Also in various embodiments, the vehicle information of 508 is also provided from the sensing module 410 to the processing module 420 as pre-processed, tokenized sensor data pertaining to various actors from the sensor data of 502, for use in vehicle control. With reference again to the architecture 600 of FIG. 6, the vehicle information of 508 is represented as vehicle information 610 with respect to a current time (t).

The actor information is provided to a first neural network at 510. In various embodiments, the actor information of 506 is provided at multiple points in time to a deep recurrent neural network (or “Deep RNN”) as inputs 415 for the processing module 420 of FIG. 4 for processing thereby using the Deep RNN (e.g., by the processor 44 of the controller 34 of FIG. 1).

With reference to FIG. 6, the first actor information 602 is provided to Deep RNN 606 at a first time (e.g., a previous time t−1), and the second actor information 604 is provided to the Deep RNN at a second time (e.g., a current time t). For example, as shown in FIG. 6, in various embodiments, parameters (e.g., actor type, position, heading angle, distance from the host vehicle 10, velocity, acceleration, and so on) for each actor (i.e., a1, a2, . . .) are provided to the Deep RNN 606 for processing at various times as the vehicle 10 is operating (e.g., including times t−1, t, and so on). In various embodiments, the Deep RNN 606 is stored in a memory onboard the vehicle, such as the computer readable storage device or media 46 of FIG. 1.

As shown in FIG. 6, in various embodiments, the Deep RNN 606 provides information as to the surroundings for the vehicle 10 at various points in time based on the actor information 602, 604. Also as shown in FIG. 6, in various embodiments, the Deep RNN 606 has multiple layers of complexity. For example, in one particular example involving a vehicle turn: (i) a first level for the Deep RNN 606 may include values WA that are the parameters themselves for the actors (e.g., actor type, position, heading angle, distance from the host vehicle 10, velocity, acceleration); (ii) a second level for the Deep RNN 606 may include values W_{1,2} representing extracted information from lower layers of the Deep RNN 606 (e.g., serving as feature extractors); (iii) a third level for the Deep RNN 606 may include values W_{2,3} representing extracted information from further lower layers of the Deep RNN 606 (e.g., serving as further feature extractors), and so on, until (iv) a final level for the Deep RNN 606 may include values W_{d-1,d} that represent extracted information from further lower layers of the Deep RNN 606 (e.g., serving as further feature extractors). In various embodiments, the different “W” values may be learned in an end-to-end manner. For example, in certain embodiments, the higher level relevant information of the actors may be learned by only observing the human driver, for example as the ground truth for this higher level information may not be readily or explicitly available.

With reference back to FIG. 5, in various embodiments, outputs are generated from the first neural network at 512. In various embodiments, the outputs of 512 include details pertaining to the surroundings for the vehicle 10, including the various processed parameters for the various actors. In various embodiments, such outputs 512 may include the current and future expected paths for the various actors with respect to the host vehicle 10. With reference to FIG. 6, the first neural network outputs are represented as outputs 614. In various embodiments, the outputs 614 are fixed in nature. For example, in various embodiments, although the inputs to the Deep RNN 606 at different time stamps could have various sizes (e.g., due to presence of different actors in the scene) the output 614 of the Deep RNN 606 is a fixed-dimensional vector (having a fixed size) that could be fed to a deep neural network. In other words, in various embodiments, the output 614 provides a canonical representation for all the actors in the scene. Also in various embodiments, the outputs are generated by the Deep RNN 606 of FIG. 6 via the processing module 420 of FIG. 4 (e.g., via the processor 44 of the controller 34 of FIG. 1).

Also in various embodiments, at 514, the first neural network outputs of 512 are provided, along with the vehicle information of 508, to a second neural network. In various embodiments, the first neural network outputs of 512 and the vehicle information of 508 are provided to a second neural network comprising a deep neural network (or “Deep NN”) for further processing by the processing module 420 of FIG. 4 using the Deep NN (e.g., by the processor 44 of the controller 34 of FIG. 1), in order to generate vehicle control recommendations (i.e., recommended control actions) for the vehicle 10 as outputs of the second neural network (i.e., the Deep NN).

With reference to FIG. 6, the outputs 614 of the Deep RNN 606, along with the vehicle information 610, are provided to Deep NN 616 for processing. Also as shown in FIG. 6, in various embodiments, the Deep NN 616 has multiple layers of complexity. For example, in one particular example, for each type of vehicle control (e.g., braking, accelerating, steering, and so on), the various levels of the Deep NN 616 comprise representations that the machine (e.g., processor) learns implicitly. In various embodiments, the Deep RNN 606 includes various layers that represent values and/or instructions that the machine (e.g., processor) learns in order to provide outputs that include acceleration, deceleration, steering, and the like (e.g., per the discussion below) at the inputs representing various driving situations.

With reference back to FIG. 5, in various embodiments, outputs are generated from the second neural network at 516. In various embodiments, the outputs of 516 include detailed recommendations as to various vehicle control parameters (e.g., including magnitudes and/or directions, as appropriate, for steering, braking, acceleration, and so on). With respect to FIG. 6, the second neural network outputs are represented as outputs 618. In various embodiments, the outputs 618 are generated by the Deep NN 616 of FIG. 6 via the processing module 420 of FIG. 4 (e.g., via the processor 44 of the controller 34 of FIG. 1).

Also in various embodiments, host vehicle information is updated at 518. Specifically, in various embodiments, the vehicle data of 508 (e.g., corresponding to vehicle data 610 of FIG. 6) is updated to reflect the second neural network outputs of 516, along with any updated vehicle information of 508 at new and/or subsequent points in time (e.g., via updated sensor data).

In various embodiments, a determination is made at 520 as to whether the vehicle 10 is in a training mode versus an operational mode. For example, in various embodiments, if the first and second neural networks are being trained for subsequent use, then the vehicle 10 would be considered to be in the training mode. Conversely, also in various embodiments, if the first and second neural networks are already trained, and are being used in an operational mode for use in controlling the vehicle 10, then the vehicle 10 would be considered to be in the operational mode. In various embodiments, this determination is made by the processing module 420 of FIG. 4, for example via the processor 44 of the controller 34 of FIG. 1.

If it is instead determined at 520 that the vehicle 10 is in the training mode, then the process proceeds along a first path 521, as operator actions are observed at 522. Specifically, in various embodiments, observations are made as to actions of a human operator of the vehicle 10 (e.g., a driver inside the vehicle 10, in certain embodiments). In various embodiments, the observations made be made via the sensing module 410 of FIG. 4 (e.g., via sensors 40a-40n of FIG. 1), for example with respect to a human operator's engagement of one or more vehicle controls (e.g., engagement of a steering wheel, accelerator pedal, brake pedal, and the like) and/or the results of such action (e.g., the resulting position, heading, velocity, acceleration, deceleration, and the like, and/or changes thereof), in various embodiments. With reference to FIG. 6, the observed operator actions are represented as observed actions 620. Also as depicted in FIG. 6, in various embodiments, the process 500 is performed in the training mode for various different human operators 1, 2, . . . n (e.g., at different times and/or for different vehicle 10s), thereby resulting in different observed actions 620(1), 620)(2), . . . 620(n) for the various different operators.

In various embodiments, comparisons are made at 524 between the neural network recommendations of 516 and the operator actions observed at 522. Specifically, in various embodiments, comparisons are made between the outputs/recommendations 618 from the second neural network (i.e., the Deep NN 616 of FIG. 6) and the operator actions (i.e., the operator actions 620(1), 620(2), . . . 620(n)). In various embodiments, the comparisons are used to determine differences between the recommended actions from the second neural network and the actual actions from the human operator(s). In various embodiments, the comparisons and determinations are made by the processing module 420 of FIG. 4 (e.g., via the processor 44 of the controller 34 of FIG. 1).

Also in various embodiments, the comparisons of 524 are used to update the first neural network (at 526) and the second neural network (at 528). Specifically, with reference to FIG. 6, in various embodiments, back-propagation 622 is utilized to provide first updates 624 for the Deep RNN 606 and second updates 626 for the Deep NN 616 of FIG. 6 based on the differences between the human operator actions (i.e., operator actions 620) and the recommended actions (i.e., outputs 618). This enables the first and second neural networks (i.e., the Deep RNN 606 and the Deep NN 616 of FIG. 6) to learn from the human operators, and for refinement of the neural networks to be further trained and fine-tuned to emulate the human operators' actions for subsequent operation of the process 500 in the operational mode.

Also in various embodiments, a determination is made at 530 as to whether the vehicle 10 is still in operation. In various embodiments, this determination is made by the processing module 420 of FIG. 4 (e.g., via the processor 44 of the controller 34 of FIG. 1). In various embodiments, if it is determined that the vehicle 10 is still in operation (and/or that vehicle control via the process 500 is still desired), then the process returns to step 504, and continues with a new iteration (e.g., with updated values, determinations, and training for the neural network models in the training mode). Otherwise, in various embodiments, the process terminates at 540.

With reference back to 520, if it is determined instead that the vehicle 10 is in the operational mode, then the process proceeds along a second path 531, as instructions for vehicle control are generated at 532. Specifically, in various embodiments, instructions are provided for specific control of one or more vehicle functions (e.g., a magnitude and/or direction, as appropriate, for braking, accelerating, decelerating, stopping, steering, initiating a turn, and so on) based on the recommendations of 516 (e.g., from the Deep NN 616 of FIG. 6). In various embodiments, the instructions correspond to outputs 425 of FIG. 4, and are generating by the processing module 420 of FIG. 4 (e.g., via the processor 44 of the controller 34 of FIG. 1).

Also in various embodiments, the instructions are implemented at 534. In various embodiments, the instructions of 532 are implemented at 534 via one or more actuators 42a-42n that control vehicle features pertaining to the instructions, for example pertaining to the propulsion system 20, the transmission system 22, the steering system 24, the brake system 26, and son, thereby resulting in the desired vehicle actions.

Also in various embodiments, a determination is made at 536 as to whether the vehicle 10 is still in operation. In various embodiments, this determination is made by the processing module 420 of FIG. 4 (e.g., via the processor 44 of the controller 34 of FIG. 1). In various embodiments, if it is determined that the vehicle 10 is still in operation (and/or that vehicle control via the process 500 is still desired), then the process returns to step 504, and continues with a new iteration (e.g., with updated values, determinations, and actions in the operational mode). Otherwise, in various embodiments, the process terminates at 540.

Accordingly, methods, systems, and vehicles are provided that provide for potentially improved vehicle control using neural network models. Specifically, in various embodiments, tokenized sensor inputs are utilized for training first and second neural network models to learn from human operators in a training mode and to provide for resulting control of various vehicle actions during an operation mode.

Per the discussion above, in various embodiments, multiple neural networks serve as driving decision models that are trained from real human driver behavior. Also in various embodiments, the inputs to the four phase neural networks include the actor information and the vehicle information at time t, and the outputs include vehicle control predictions at time t+t1 and time t+t2.

In various embodiments, a robust autonomous driving system is provided with human-like decision making capability, which sets the speed of the autonomous vehicle on a fixed path. In various embodiments, an end-to-end system is provided, that builds on state of the art machine learning systems, and is capable of translating multi-modal information tokens extracted from vehicle's sensors into driving decisions. A four-phase process is provided, which allows for reliable decision making based on sensor information tokens. In various embodiments, the inputs to the system include tokenized information from all the actors (i.e. cars, pedestrians, cyclists, etc.) at time tt which includes actors' location, speed, and heading angle. In the first phase the tokenized information is preprocessed to make it dimensionless. In the second phase, the dimensionless tokenized information from all actors combined with the current velocity of the (self) autonomous car and its location is fed to a Recurrent Neural Network (RNN), which encodes this information into a fixed-size standardized feature vector that captures the essence of the scenario situation at time tt. In the third phase, the RNN feature is passed to a deep Neural Network, which maps the encoded actors' information into a driving decision and determines the speed of the autonomous vehicle at time tt+Δtt. Finally, the determined velocity and the location of the autonomous vehicle at time tt+Δtt are fed back to the RNN to be used for determining the velocity at time tt+2 Δtt in the fourth phase.

In various embodiments, the disclosed methods, systems, and vehicles provide for a canonical representation of the output of a recurrent neural network, along with the use of a deep neural network to regress over this canonical representation and to predict vehicle actions (e.g., steering, acceleration, deceleration, and so on), for training of autonomous vehicles, including driver learning for an autonomous vehicle using multiple neural networks, as described above.

As mentioned briefly, the various modules and systems described above may be implemented as one or more machine learning models that undergo supervised, unsupervised, semi-supervised, or reinforcement learning. Such models might be trained to perform classification (e.g., binary or multiclass classification), regression, clustering, dimensionality reduction, and/or such tasks. Examples of such models include, without limitation, artificial neural networks (ANN) (such as a recurrent neural networks (RNN) and convolutional neural network (CNN)), decision tree models (such as classification and regression trees (CART)), ensemble learning models (such as boosting, bootstrapped aggregation, gradient boosting machines, and random forests), Bayesian network models (e.g., naive Bayes), principal component analysis (PCA), support vector machines (SVM), clustering models (such as K-nearest-neighbor, K-means, expectation maximization, hierarchical clustering, etc.), and linear discriminant analysis models.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

1. A method comprising:
obtaining first sensor inputs pertaining to one or more actors in proximity to an autonomous vehicle;
obtaining second sensor inputs pertaining to operation of the autonomous vehicle;
obtaining, via a processor, first neural network outputs via a first neural network, using the first sensor inputs; and
obtaining, via the processor, second neural network outputs via a second neural network, using the first network outputs and the second sensor inputs, the second neural network outputs providing one or more recommended actions for controlling the autonomous vehicle.

2. The method of claim 1, wherein the first neural network comprises a recurrent neural network.

3. The method of claim 2, wherein:
the first neural network comprises a deep recurrent neural network; and
the second neural network comprises a deep neural network.

4. The method of claim 1, wherein:
the step of obtaining the first sensor inputs comprises obtaining first operational parameters for one or more other vehicles in proximity to the autonomous vehicle; and
the step of obtaining the first neural network outputs comprises obtaining the first neural network outputs, via the first neural network, using the first operational parameters for the one or more other vehicles in proximity to the autonomous vehicle.

5. The method of claim 1, further comprising:
providing one or more vehicle actions for controlling acceleration, deceleration, or steering of the autonomous vehicle, when the autonomous vehicle is in an operational mode.

6. The method of claim 1, further comprising, when the autonomous vehicle is in a training mode:
obtaining observational data pertaining to a human's operation of the autonomous vehicle;
comparing the human's operation of the autonomous vehicle from the observational data with the recommended actions of the second neural network outputs; and
updating the first neural network and the second neural network based on the comparing of the human's operation of the autonomous vehicle from the observational data with the recommended actions of the second neural network outputs.

7. The method of claim 1, wherein:
the step of obtaining the first sensor inputs comprises obtaining tokenized sensor inputs pertaining to one or more actors in proximity to an autonomous vehicle; and
the step of obtaining the first neural network outputs comprises obtaining the first neural network outputs via the first neural network, using the tokenized sensor inputs pertaining to one or more actors in proximity to an autonomous vehicle.

8. A system comprising:
a sensing module for an autonomous vehicle, the sensing module configured to at least facilitate:
obtaining first sensor inputs pertaining to one or more actors in proximity to an autonomous vehicle; and
obtaining second sensor inputs pertaining to operation of the autonomous vehicle; and
a processing module having a processor, and that is coupled to the sensing module and configured to at least facilitate:
obtaining first neural network outputs via a first neural network, using the first sensor inputs; and
obtaining second neural network outputs via a second neural network, using the first neural network outputs and the second sensor inputs, the second neural network outputs providing one or more recommended actions for controlling the autonomous vehicle.

9. The system of claim 8, wherein the first neural network comprises a recurrent neural network.

10. The system of claim 9, wherein:
the first neural network comprises a deep recurrent neural network; and the second neural network comprises a deep neural network.

11. The system of claim 8, wherein:
the sensing module is configured to at least facilitate obtaining first operational parameters for one or more other vehicles in proximity to the autonomous vehicle; and
the processing module is configured to at least facilitate obtaining the first neural network outputs, via the first neural network, using the first operational parameters for the one or more other vehicles in proximity to the autonomous vehicle.

12. The system of claim 8, wherein the processing module is configured to at least facilitate providing one or more vehicle actions for controlling acceleration, deceleration, or steering of the autonomous vehicle, when the autonomous vehicle is in an operational mode.

13. The system of claim 8, wherein the processing module is configured to at least facilitate, when the autonomous vehicle is in a training mode:
obtaining observational data pertaining to a human's operation of the autonomous vehicle;
comparing the human's operation of the autonomous vehicle from the observational data with the recommended actions of the second neural network outputs; and
updating the first neural network and the second neural network based on the comparing of the human's operation of the autonomous vehicle from the observational data with the recommended actions of the second neural network outputs.

14. The system of claim 8, wherein:
the sensing module is configured to at least facilitate obtaining tokenized sensor inputs pertaining to one or more actors in proximity to an autonomous vehicle; and
the processing module is configured to at least facilitate obtaining the first neural network outputs via the first neural network, using the tokenized sensor inputs pertaining to one or more actors in proximity to an autonomous vehicle.

15. An autonomous vehicle comprising:
a body;
a propulsion system configured to move the body;
one or more sensors disposed within the body, the one or more sensors configured to at least facilitate:
obtaining first sensor inputs pertaining to one or more actors in proximity to an autonomous vehicle; and
obtaining second sensor inputs pertaining to operation of the autonomous vehicle; and
one or more processors disposed within the body, the one or more processors configured to at least facilitate:
obtaining first neural network outputs via a first neural network, using the first sensor inputs; and
obtaining second neural network outputs via a second neural network, using the first neural network outputs and the second sensor inputs, the second neural network outputs providing one or more recommended actions for controlling the autonomous vehicle.

16. The autonomous vehicle of claim 15, wherein:
the first neural network comprises a deep recurrent neural network; and the second neural network comprises a deep neural network.

17. The autonomous vehicle of claim 15, wherein:
the one or more sensors are configured to at least facilitate obtaining first operational parameters for one or more other vehicles in proximity to the autonomous vehicle; and
the one or more processors are configured to at least facilitate obtaining the first neural network outputs, via the first neural network, using the first operational parameters for the one or more other vehicles in proximity to the autonomous vehicle.

18. The autonomous vehicle of claim 15, wherein the one or more processors are configured to at least facilitate:
when the autonomous vehicle is in an operational mode, providing one or more vehicle actions for controlling acceleration, deceleration, or steering of the autonomous vehicle; and
when the autonomous vehicle is in a training mode:
obtaining observational data pertaining to a human's operation of the autonomous vehicle;
comparing the human's operation of the autonomous vehicle from the observational data with the recommended actions of the second neural network outputs; and
updating the first neural network and the second neural network based on the comparing of the human's operation of the autonomous vehicle from the observational data with the recommended actions of the second neural network outputs.

19. The autonomous vehicle of claim 15, wherein:
the one or more sensors are configured to at least facilitate obtaining tokenized sensor inputs pertaining to one or more actors in proximity to an autonomous vehicle; and
the one or more processors are configured to at least facilitate obtaining the first neural network outputs via the first neural network, using the tokenized sensor inputs pertaining to one or more actors in proximity to an autonomous vehicle.

20. The autonomous vehicle of claim 15, further comprising:
a memory disposed within the body and configured to store the first neural network and the second neural network.
